(19) United States
(12) Patent Application Publication
(10) Pub. No.: US 2025/0293428 A1
(43) Pub. Date: Sep. 18, 2025

(54) WIDEBAND RADIATOR WITH HIGH ANTENNA PORT ISOLATION

(71) Applicant: Telefonaktiebolaget LM Ericsson (publ), Stockholm (SE)

(72) Inventor: Marko Sonkki, Rosenheim (DE)

(21) Appl. No.: 18/860,776

(22) PCT Filed: Apr. 27, 2022
(86) PCT No.: PCT/EP2022/061273

§ 371 Date: Oct. 28, 2024

(51) Int. Cl. H01Q 1/52

(52) U.S. Cl. CPC H01Q 1/523

(57) ABSTRACT

A multimode antenna comprising: a conducting body; and a first and a second antenna port, which are respectively adapted for excitation of a first and a second set of radiation modes, all radiation modes sharing a common boundary curve at which an electric boundary condition, EBC, or a magnetic boundary condition, MBC, is satisfied. The first set consists of multiple radiation modes for which the EBC is satisfied at the common boundary curve, and the second set consists of multiple radiation modes for which the MBC is satisfied at the common boundary curve. In an embodiment, the first and second antenna ports are adapted for simultaneous excitation of multiple radiation modes of the first and second sets.

### TECHNICAL FIELD

The present disclosure is generally related to the field of antenna technology. It presents, in particular, a multimode antenna with mutually isolated first and second antenna ports for exciting multiple radiation modes each.

### BACKGROUND

A main challenge in the design of frequency division duplexing (FDD) and full-duplex (FD) networks is the self-interference caused by the own transmission (Tx) on the signal in reception (Rx). The transmission may interfere with the reception by blocking the reception signal due to limited linearity of the receiver, or the transmission generates wideband noise overlapping with the received signal. In the extreme case of FDD, called in-band full duplex, the frequency spacing between Tx and Rx is zero, i.e., transmitter and receiver operate contemporaneously on the same channel. Each frequency band requires a dedicated duplex filter to isolate Tx signals from Rx port in the FDD radio-frequency (RF) front-end.

If the same band/channel is used for both uplink and downlink, like in LTE TDD mode, time division duplex (TDD) communication is restricted at any given time to either transmitting or receiving. As a result, any simultaneous use of the channel by more than one node within their interference range in the same network could cause the transmitted packets to collide. On the other hand, time division happens at very high rate, and it can be assumed that the transmit and receive slots are overlapping. Ensuring high isolation between the transmitter and receiver could, at least theoretically, mitigate the aforementioned problems.

Isolation between antenna ports is a desirable aim to achieve and a long-standing challenging problem to solve in practice. Literature and patents related to isolation improvement tend to mainly focus on methods and structures for self-interference cancellation, rather than the isolation between the antenna ports themselves. Another longstanding task is how to achieve the isolation over a wide frequency range, so that the antenna maintains good impedance matching and good radiation efficiency.

To achieve good isolation, relatively complicated solutions are introduced in the literature; see Kuznecov [Maksim V. Kuznetcov, Symon K. Podilchak, Ariel McDermott, Mathini Sellathurai, “Dual-Polarized Antenna with Dual-Differential Integrated Feeding for Wideband Full-Duplex Systems”, IEEE Transactions on Antennas and Propagation (Early Access), 2021, https://iceexplore.iccc.org/abstract/document/9496252] and Wang [Jing Wang, Wei Wang; Aimeng Liu, Meng Guo, Zhenyu Wei, “Broadband Metamaterial-Based Dual-Polarized Patch Antenna with High Isolation and Low Cross Polarization”, IEEE Transactions on Antennas and Propagation (Early Access), 2021, https://iceexplore.iecc.org/abstract/document/9445677], as well as the published patent U.S. Pat. No. 9,300,041B2. Further, several solutions for narrow-band applications can be found in the literature; see Xu [Hang Xu. Hai Zhou, Steven Gao, Hanyang Wang. Yujian Cheng. “Multimode Decoupling Technique with Independent Tuning Characteristic for Mobile Terminals”, IEEE Transactions on Antennas and Propagation, Vol. 65, Issue 12, 2017, pp. 6739-6751, https://iceexplore.iccc.org/abstract/document/8046066], Sonkki [ Marko Sonkki, Janne Aikio, Marko E. Leinonen, Aarno Pärssinen, “Study of Transmitter Interference to Receiver at 2 GHz with High Antenna Port Isolation”, Progress in Electromagnetics Research M, Vol. 86, pp. 183-192, 2019, https://www.jpier.org/PIERM/pierm86/18.19080105.pdf] and Zhao [Xing Zhao; Swee Ping Yeo; Ling Chuen Ong, “Planar UWB MIMO Antenna With Pattern Diversity and Isolation Improvement for Mobile Platform Based on the Theory of Characteristic Modes”, IEEE Transactions on Antennas and Propagation. Vol. 66, Issue 1, January 2018, pp. 420-425, https://iceexplore.iecc.org/document/8089749]. Several authors also present wideband solutions; see Manteuffel [D. Manteuffel, R. Martens, “Compact Multimode Multielement Antenna for Indoor UWB Massive MIMO”, IEEE Transactions on Antennas and Propagation. Vol. 64, Issue 7, July 2016, pp. 2689-2697, https://iceexplore.iccc.org/document/7431947] and Peitzmeier [Nikolai Peitzmeier, Tim Hahn, Dirk Manteuffel, “Systematic Design of Multimode Antennas for MIMO Applications by Leveraging Symmetry”, IEEE Transactions on Antennas and Propagation, Vol. 70, Issue 1, 2022, https://iceexplore.iccc.org/stamp/stamp.jsp?tp=&arnumber=9496169]. The literature in this field also knows antenna structures based on the theory of characteristic modes, where multiple ports are used to excite multiple specific modes, though this is achieved at the cost of significant extra volume; see Manteuffel. Peitzmeier and Benlliure [Jaime Molins-Benlliure, Eva Antonino-Daviu, Marta Cabedo-Fabres, Miguel Ferrando-Bataller, “Four-Port Wide-Band Cavity-Backed Antenna with Isolating X-Shaped Block for Sub-6 GHz 5G Indoor Base Stations”, IEEE Access, Vol. 9, 2021, pp. 80535-80545, https://iceexplore.iccc.org/abstract/document/9443095].

Achieving a sufficient isolation between Tx and Rx is a major challenge. In the prior art, this is implemented in steps. First, sufficient RF isolation/cancellation or analog isolation/cancellation is required to avoid any compression in the receiver analog signal processing, and to avoid an excessive number of additional bits in analog-to-digital converter (ADC). Secondly, the digital signal processing is needed to do the rest. Any additional RF isolation that can be provided will relax design and signal processing requirements. Thus, an antenna structure that provides good isolation between Tx and Rx ports will significantly assist system design and specifications of other blocks.

Multimode antennas are radiators where two or more modes are efficiently excited over the same frequency band to gain diversity. More than two antenna ports are needed to excite these modes simultaneously, for which a dedicated feed network can be used. Isolation between the antenna ports is usually in the range of 15 to 25 dB. Prior art multimode antennas need an added volume for the feed network and, thus, a wideband planar structure is hard to implement.

The prior art multimode antennas can isolate the Tx signal from the Rx signal with 15 to 25 dB of isolation. To achieve an additional 20 dB of isolation, decoupling networks, hybrid couplers or duplex filters are introduced, which are complex and reduce the bandwidth significantly (5-10%). Alternative technologies apt to achieve such additional isolation without the mentioned drawbacks would be of high value. In particular, it could help relax the requirements on the subsequent signal processing elements, such as RF filters.

### SUMMARY

One objective of the present disclosure is to make available a multimode antenna with excellent antenna-port isolation. In particular, a port-to-port isolation between a first and a second antenna port on the multimode antenna should be at least 20 dB, preferably at least 35, 40 or 45 dB. Further, the multimode antenna should achieve such port-to-port isolation over a wide frequency range. It is a specific objective to make available a multimode antenna with a planar conducting body. A still further objective is to present a method for designing a multimode antenna with excellent antenna-port isolation and a wide frequency range.

In a first aspect, there is proposed a multimode antenna comprising a conducting body, as well as a first and a second antenna port. The antenna ports are respectively adapted for excitation of a first set of radiation modes and a second set of radiation modes, wherein all radiation modes share a common boundary curve at which an electric boundary condition (EBC) or a magnetic boundary condition (MBC) is satisfied. The first set consists of multiple radiation modes for which the EBC is satisfied at the common boundary curve. The second set consists of multiple radiation modes for which the MBC is satisfied at the common boundary curve. The location of the common boundary is not essential.

The multimode antenna according to the first aspect utilizes multiple orthogonal radiating modes on a conducting body to enable operation over a wide frequency range. The two separate antenna ports enable excitation of orthogonal or near-orthogonal radiating modes. With the multimode antenna according to the first aspect, an 80% relative −10 dB impedance bandwidth, 68-98% radiation efficiency, and better than 40 dB antenna port isolation can be achieved within the bandwidth. Wireless communication modes where high isolation is needed between transmitter and receiver include FD FDD, multiple-input multiple-output (MIMO) and TDD. When the isolation between the transmitter and receiver is high, the filtering requirements can be relaxed, and the RF front-end design can be done more flexibly. In comparison with the above-referenced prior art, the first aspect makes available an antenna structure that is simple, yet has excellent antenna port isolation and good radiation properties over a substantial bandwidth. At least some of these benefits are owed to the ability to excite multiple orthogonal radiating modes, so that, even if energy leakage between ports occurs, the resulting excitation is limited thanks to orthogonality.

In the present disclosure and the claims in particular, an “antenna port” shall refer to a physical antenna port. Accordingly, the scope of this term is different from the concept of a logical or virtual antenna port; this includes the purely functional definitions in 3GPP LTE or 3GPP NR specifications, where an antenna port is understood abstractly in such manner “that the channel over which a symbol on the antenna port is conveyed can be inferred from the channel over which another symbol on the same antenna port is conveyed” (see 3GPP TS 36.211, clause 5.2.1).

Further, a common “boundary curve” in the sense of the claims is independent of the physical structure of the multimode antenna. In particular, it need not correspond to any ridge, groove, notch, material interface or the like on the conducting body. Instead, the common boundary curve may be a feature that can be observed only in the excitable radiation modes. In other words, the common boundary curve can be identified by performing electric or magnetic measurements (especially local current measurements) during excitation or performing computer-aided simulations, but not necessarily by inspecting the conducting body at rest. The boundary curve may locally have zero or non-zero curvature; in particular, the boundary curve may coincide with a straight symmetry line on the conducting body.

The EBC may be considered satisfied if the electric field's tangential component vanishes at the common boundary curve. Additionally or alternatively, the MBC may be considered satisfied if the electric field's tangential component is continuous across the common boundary curve. For the avoidance of doubt, it is understood that the criteria “vanishes” (i.e., is zero) and “is continuous” are to be evaluated within the accuracy of the application at hand, and in accordance with the applicable measuring tolerance of the implementation.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

According to a second aspect of the present disclosure, the multimode antenna forms part of an antenna system, which further comprises a feed network configured to generate electromagnetic waves to be applied to the antenna ports via feedlines, and the electromagnetic waves are suitable for simultaneously exciting at least three radiation modes of the first or second sets of radiation modes.

According to a third aspect, there is provided a method of designing a multimode antenna. The method comprises: obtaining a geometric description of the conducting body included in the multimode antenna; simulating, based on the geometric description, a plurality of radiation modes of the conducting body; identifying a first set of radiation modes each of which satisfies an electric boundary condition, EBC, at a common boundary curve; identifying a second set of radiation modes each of which satisfies a magnetic boundary condition, MBC, at said common boundary curve; and providing a geometric description of a first and a second antenna port, which are respectively adapted for excitation of the first and the second set of radiation modes. The simulating, which may be computer-assisted, can include the use of characteristic mode analysis (CMA) techniques.

The design method according to the third aspect allows the provisioning of a multimode antenna with the beneficial properties discussed above using, as starting point, a conducting body with arbitrary geometry. It is understood that the conducting body's degree of suitability can be highly dependent on the geometry, so that optimal performance may not be expected for all conceivable geometries. This said, the availability of the design method assists the integration of multimode antennas with such beneficial properties into complex products, including spatially constrained implementations.

### BRIEF DESCRIPTION OF THE DRAWINGS

Aspects and embodiments are now described, by way of example, with reference to the accompanying drawings, on which:

FIG. 1 are top views of four multimode antenna geometries;

FIG. 2a illustrates two radiation modes satisfying an MBC at respective boundary curves drawn with dashed line, and FIG. 2b illustrates two radiation modes satisfying an EBC at respective boundary curves, wherein the arrows represent current;

FIG. 3a illustrates six radiation modes satisfying an EBC at a common boundary curve, and FIG. 3b illustrates six radiation modes satisfying an MBC at a common boundary curve, wherein arrows represent the local direction of current and the shading represents the density of current;

FIG. 4a illustrates a placement of two electric dipole sources relative to a boundary curve such that an EBC is satisfied, and FIG. 4b illustrates a placement of two electric dipole sources relative to a boundary curve such that an MBC is satisfied;

FIG. 5 includes, in the upper half, a plot of simulated and measured values of S-parameters for the multimode antenna and, in the lower half, a plot of simulated and measured values of the total efficiency of each port of the multimode antenna;

FIG. 6 contains plots of measured radiation patterns respectively measured at 1.5 GHZ (first column), 2.5 GHz (second column) and 3.5 GHZ (third column) for the structure shown in FIG. 1c, wherein the upper and lower plots in each column refer to the first and second antenna ports, respectively, and each plot contains an XY section (thick solid line), an XZ section (thin solid line) and a YZ section (dashed line) relative to a cartesian reference frame;

FIG. 7a illustrates, in block-diagram form, a prior art antenna system in which a duplex filter is used to isolate the transmitted signal (Tx) from the received signal (Rx) at approximately 40 dB;

FIG. 7b shows an antenna system with a multimode antennas according to the present disclosure, in which good antenna port isolation is achieved without little or no need for such duplex filtering;

FIG. 8 illustrates wiring patterns by which antenna feed points within each antenna port can be coupled by co-planar wave guides, whereby the necessary number of feedlines (or their total length) can be reduced;

FIG. 9 are side views illustrating embodiments where the conducing body is locally curved (bent); and

FIG. 10 is a flowchart of a method of designing a multimode antenna.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

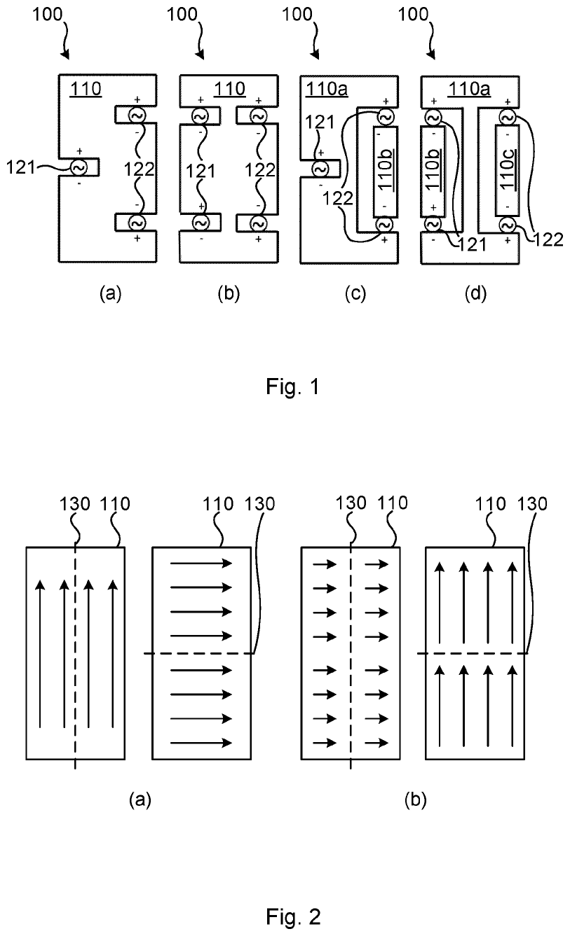

Each of FIGS. 1a, 1b, 1c and 1d is a top view of a multimode antenna 100 according to embodiments herein. The multimode antenna 100 includes a conducting body 110 with at least a first antenna port 121 and a second antenna port 122. The conducting body 110 can be monolithic, or it can be segmented into multiple segments 110a, 110b, 110c which are pairwise electrically insulated. The conducting body 110 is planar in the illustrated embodiment. The horizontal proportions and other geometrical aspects of the conducting body 110 are not necessarily drawn to scale in FIG. 1. The antenna ports 121, 122 are physical antenna ports, and each antenna port may include one or more one feed points suitable for accepting a signal (drive signal). The signal, which may optionally be polarized, may be applied to the feed point by inductive or capacitive coupling. In the case of inductive coupling, each feed point has a positive and negative pole, as indicated by the plus and minus signs in FIG. 1, arranged across (on the two sides of) a slot. The slot may be an interface between two adjacent segments of the conducting body, or it may have been cut (machined) in a single segment. The location of the slot, and thus of the feed point, may correspond approximately to a current maximum (antinode) of the radiation modes to be excited by the antenna port to which the feed point belongs.

To supply the antenna ports 121, 122 with the signal, a suitable feed network (not shown) may be provided, which may include circuitry of a simple or relatively more complex design depending on the requirements of the intended application. The feed network shall be capable of providing a signal with a well-defined frequency content, namely, the eigenfrequencies of the radiation modes that are currently to be excited, and suppressing as far as practicable any further frequency components. The feed network is connected to the antenna ports 121, 122 over feedlines, which may be provided as waveguides or coaxial cables. The corresponding feed point or feed points are arranged in proximity of a portion of the feedline and are thereby coupled to the feedline by inductive or capacitive interaction.

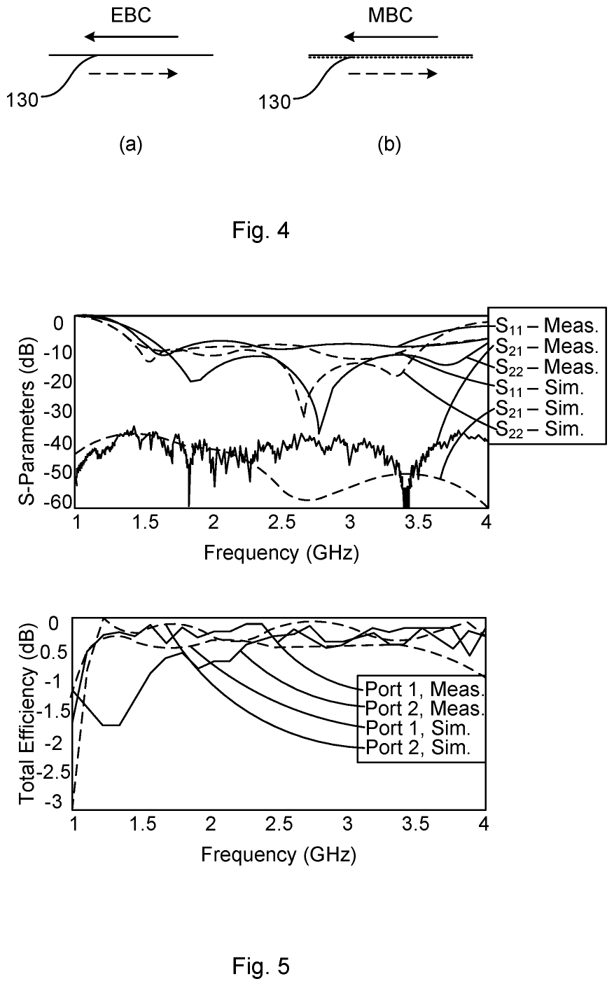

The feed point(s) of the first antenna port 121 shall be so positioned on the conducting body 110 as to favor excitation of the first set of radiation modes, and the feed point(s) of the second antenna port 122 shall be so positioned on the conducting body 110 as to favor excitation of the second set of radiation modes. It is recalled that the first set consists of such radiation modes for which the EBC is satisfied at a common boundary curve (not shown), and that the second set consists of such radiation modes for which the MBC is satisfied at the common boundary curve. The EBC may be considered satisfied if the electric field's tangential component (or current) vanishes at the common boundary curve; this is to say, the only nonzero component of the electric field is normal to the conducting surface in which the boundary curve is located. The MBC may be considered satisfied if the tangential component of the oscillating electric field is continuous across the common boundary curve; for the MBC, the tangential component of the associated oscillating magnetic field vanishes and/or the normal component of the oscillating magnetic field is continuous across the boundary curve. Reference is made to FIG. 4a, which illustrates a placement of two electric dipole sources relative to a boundary curve such that, by virtue of cancellation, an EBC is satisfied. Similarly, FIG. 4b illustrates a placement of two electric dipole sources relative to a boundary curve such that an MBC is satisfied. The lower dipole source in FIG. 4a can be imagined to be the image of the upper dipole source (so-called virtual source) below an electric conductor; the lower dipole source in FIG. 4b can be imagined to be the image of the upper dipole source below a magnetic conductor.

The proposed multimode antenna 100 can be used as a coupling element or tuning element to modify the performance of an antenna or an antenna array. Alternatively, the antenna can be utilized in mobile devices, customer-premises equipment (CPE), antennas to be installed in vehicles, and wireless repeaters. Further envisioned applications are small-cell base stations, where the radio channel can be assumed to be significantly affected by scattering. Still further, two-dimensional (planar) and three-dimensional (conformal, cylindrical etc.) wideband phased arrays are potential applications. Also applications where high isolation between transmitter and receiver is required have been contemplated. e.g., full-duplex FDD.

The port-to-port isolation of the first and second antenna ports 121, 122 may be of the order of 20 dB or more, preferably at least 35 dB, preferably at least 40 dB, and most preferably at least 45 dB. Reference is made to FIG. 5. The upper half is a plot (respectively using solid and dashed line) of measured and simulated values of S-parameters (components S₁₁, S₂₁, S₂₂ of a scattering matrix) for the multimode antenna 100. The lower half of FIG. 5 is a plot of measured and simulated values of the total efficiency of each antenna port 121, 122 of the multimode antenna 100. The measurements were carried out on a planar structure fabricated on printed circuit board. It is seen in FIG. 5 that the multimode antenna 100 presents 1.5-3.5 GHz measured-10 dB impedance bandwidth (80% relative impedance bandwidth) with better than 40 dB isolation between the antenna ports. Measured total efficiencies of both ports vary between 68 and 98%.

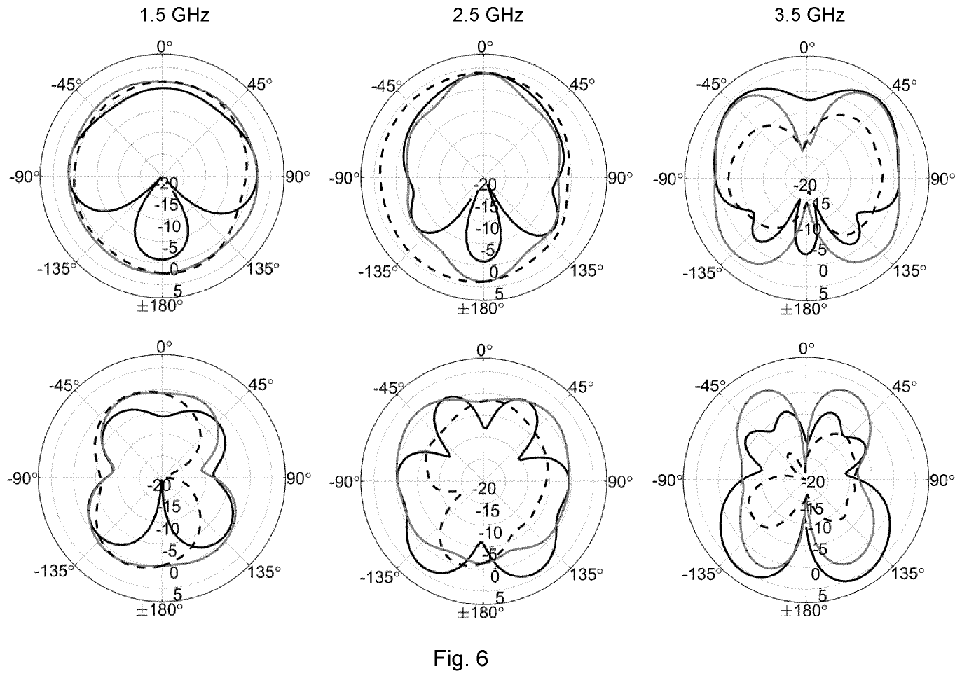

FIG. 6 are plots of measured radiation patterns respectively measured at 1.5 GHZ (first column), 2.5 GHZ (second column) and 3.5 GHz (third column) for the structure shown in FIG. 1c, wherein the upper and lower plots in each column refer to the first and second antenna ports, respectively. Each plot contains an XY section (thick solid line), an XZ section (thin solid line) and a YZ section (dashed line) relative to a cartesian reference frame. In standard spherical coordinates. ϕ=0 corresponds to the X axis of the cartesian reference frame (rightward direction in FIG. 1c), and θ=0 corresponds to the Z axis (outward direction in FIG. 1c, towards the viewer).

The proposed multimode antenna structure described herein is scalable and can therefore be used for example in the mm-Wave band. For example, an 80% relative −10 dB impedance bandwidth means 24-56 GHz bandwidth at mm-Wave frequencies. This fulfils the mm-Wave Frequency Range 2 (FR2) in 3GPP NR, which is defined from 24.25 GHz to 52.60 GHz. By downward scaling, furthermore, the multimode antenna structure can also be utilized for lower frequencies.

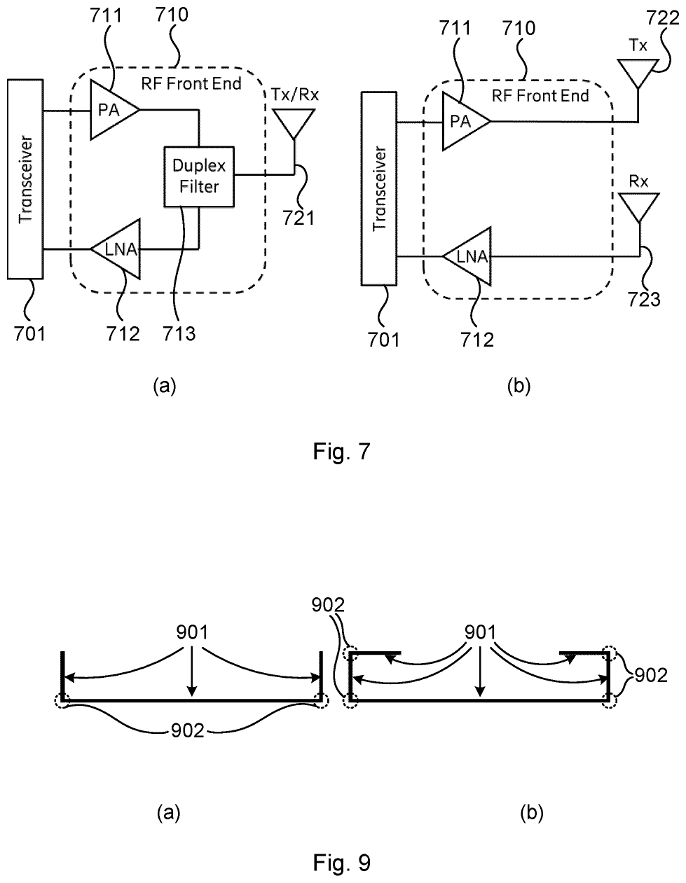

It is envisaged, within the second aspect of the present disclosure, to utilize the first and second antenna ports 121, 122 in an antenna system for transmission only and reception only, or vice versa. The inherent antenna port isolation of the multimode antenna 100 may lead to significant design simplifications, such as the removal of onerous RF filtering. Reference is made to FIG. 7a, which illustrates in block-diagram form an antenna system with an RF front end 710 according to the prior art, in which a duplex filter 713 is utilized to isolate the transmitted signal Tx from the received signal Rx at approximately 40 dB. The duplex filter 713 is arranged with a Tx/Rx antenna port 721 connected on its right-hand side, and a power amplifier 711 and a low-noise amplifier 712 connected on its left-hand side. The power amplifier 711 is responsible for the processing of a Tx signal generated by a transceiver 701 before feeding this to the antenna port 721, whereas the low-noise amplifier 712 is responsible for amplifying an Rx signal received on the antenna port 721 for further processing in the transceiver 701.

In the antenna system in FIG. 7b, by contrast, the homologous components power amplifier 711 and low-noise amplifier 712 are connected directly to a respective transmit 722 and receive 723 antenna port. Here, the transmit and receive antenna ports 722, 723 may constitute first and second antenna ports in the sense of the above-described embodiments, i.e., they are configured for excitation of a first and a second set of radiation modes, respectively fulfilling the EBC and MBC. Thanks to the approximate orthogonality of the first and second modes, equivalent performance can be achieved without the duplex filter 713, especially with respect to antenna port isolation. At least, the RF filtering requirements can be significantly relaxed, in terms of the quantitative isolation in dB and/or with respect to the complexity of the circuitry to be used.

The transceiver 701 and amplifiers 711, 712 in FIG. 7b act as a feed network. In accordance with the teachings of the present disclosure, the feed network is configured to generate electromagnetic waves suitable for simultaneously exciting at least three radiation modes of the first or second sets of radiation modes. In embodiments, the feed network is configured for simultaneous excitation of at least four such radiation modes, preferably at least six such radiation modes. In further developments of the embodiment shown in FIG. 7b, the antenna system can comprise a plurality of multimode antennas. In particular, the multimode antennas may form a phased antenna array.

In some embodiments, each radiation mode of the first set is orthogonal to each radiation mode of the second set. This contributes to good antenna port isolation, since oscillatory energy that leaks from the first 121 to the second 122 antenna port will be substantially unable to excite radiation modes in the second set.

In some embodiments, the first and second antenna ports 121, 122 are adapted for simultaneous excitation of multiple radiation modes of the first and second sets. For example, the first and second antenna ports 121, 122 may be adapted for simultaneous excitation of at least three radiation modes of the first and second sets; the first and second antenna ports 121, 122 may be adapted for simultaneous excitation of at least four radiation modes of the first and second sets; and/or the first and second antenna ports 121, 122 may be adapted for simultaneous excitation of at least six radiation modes of the first and second sets. In other words, the radiation modes to be simultaneously excited using the first and second antenna ports 121, 122 form a subset of said first and second sets of radiation modes, respectively. In various embodiments, the simultaneously excited radiation modes of the first set of radiation modes may have a total radiation bandwidth of at least 24 GHz, preferably at least 28 GHz, more preferably at least 32 GHZ, more preferably at least 36 GHZ, and most preferably at least 40 GHz. Alternatively or additionally, the simultaneously excited radiation modes of the second set of radiation modes may have a total radiation bandwidth of at least 24 GHz, preferably at least 28 GHZ, more preferably at least 32 GHZ, more preferably at least 36 GHZ, and most preferably at least 40 GHz.

Such simultaneous excitation can be made possible by the fact that, on the one hand, the boundary curve is common to all radiation modes of the first and second sets and, on the other hand, that the node/antinode structure of the radiation modes in the first and second set are mutually distinct. For example, the feed points of the first 121 (or second 122) antenna port can be positioned in areas corresponding to local maxima of the oscillating currents of all the radiation modes of the first (or second) set. In more general terminology, these local maxima constitute antinodes—or antinode lines—of the radiation modes of the first (second) set. Preferably, each feed point of the first antenna port 121 is positioned in separation from all feed points of the second antenna port 122. Particularly good port-to-port isolation can be achieved if the feed points are positioned so as to coincide with antinodes of the radiation modes of the first set and with approximate nodes of the radiation modes of the second set, and vice versa. According to these embodiments, the task of exciting the desired radiation modes is solved based on a realization that the multimode antenna's 100 useful operating bandwidth can be extended by exciting multiple orthogonal radiating modes (or clusters of modes) using the two antenna ports 121, 122, while achieving high antenna port isolation and good radiation properties. Additionally, the multimode antenna 100 according to these embodiments exploits the orthogonality of radiation modes fulfilling EBC and MBC to improve the antenna's performance.

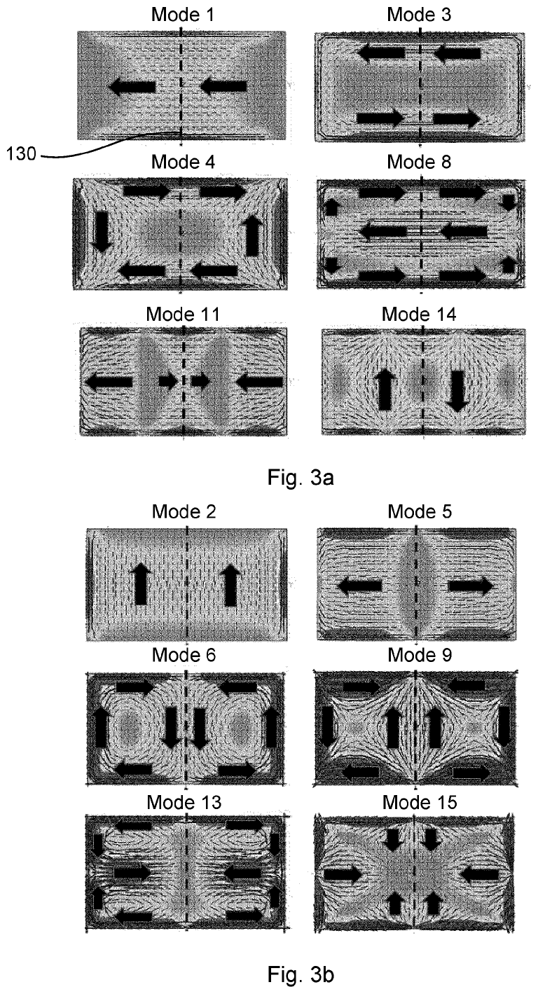

Additional understanding of the structure of the radiation modes can be gained from FIGS. 2 and 3. FIG. 2a illustrates, relating to a planar rectangular conducting body 110, two radiation modes satisfying an MBC at respective boundary curves 130 drawn with dashed line, wherein the arrows represent a snapshot of the local direction of oscillating current, which is the tangential component of the oscillating electric field. FIG. 2b illustrates two similarly drawn radiation modes satisfying an EBC at respective boundary curves 130. It is seen that the boundary curves 130 are straight symmetry lines of the conducting body 110.

FIG. 3a illustrates, for a slightly different planar antenna geometry, six radiation modes (1, 3, 4, 8, 11 and 14) satisfying an EBC at a common boundary curve. FIG. 3b illustrates six radiation modes (2, 5, 6, 9, 13, 15) satisfying an MBC at a common boundary curve. The arrows represent the local current direction, and the underlying shading represents the density of current. The radiation modes satisfying the EBC are mutually orthogonal, and the radiation modes satisfying the MBC are mutually orthogonal. All radiation modes are numbered by ascending eigenfrequency in a common numbering sequence. In one embodiment encompassed by the present disclosure, the first antenna port 121 is configured for simultaneous excitation of radiation modes 1, 3, 4, 8, 11 and 14 (FIG. 3a), whereas the second antenna port 122 is configured for simultaneous excitation of radiation modes 2, 5, 6, 9, 13, 15 (FIG. 3b). It is not mandatory to configure an antenna port for simultaneous excitation of an uninterrupted sequence of radiation modes; for example, radiation modes 7, 10 and 12 are not seen anywhere in FIG. 3. Rather, in particular embodiments, some radiation modes may be excluded if their current maxima/minima are located in a manner diverging significantly from the majority of the radiation modes in the same frequency range; the inclusion of such radiation modes could reduce the excitation efficiency or degrade the antenna-port isolation.

Returning to FIG. 1, some geometric characteristics of the depicted multimode antennas 100 will be reviewed. In FIG. 1a, the conducting body 110 is rectangle-shaped and monolithic. The first antenna port 121 has a single feed point dividing a first rectangle edge in an (approximate) length ratio 1:1, and the second antenna port 122 has two feed points dividing an opposite rectangle edge in an (approximate) length ratio 1:2:1. Each feed point is arranged across a slot cut in the conducting body 110. The feed points may be separated from the respective edges by a uniform distance, and the value of said distance is not essential to this embodiment. Equally unessential are the dimensions of the conducting body 110 in physical units, as the general appearance of the radiation modes can be expected to be invariant under scaling. Hence, although the eigenfrequencies will normally change with the length scale, the similarities of the radiation modes within each of the first and second sets are preserved, and the dissimilarities between the radiation modes of the first and second sets are too.

In FIG. 1b, the conducting body 110 is rectangle-shaped and monolithic. The first antenna port 121 has two feed points dividing a first rectangle edge in a ratio 1:2:1, and the second antenna port 122 has two feed points dividing an opposite rectangle edge in a ratio 1:2:1.

In FIG. 1c, the conducting body is rectangle-shaped and has two segments 110a, 110b. The first antenna port 121 has a single feed point dividing a first rectangle edge in a ratio 1:1, wherein said single feed point is connected to a first segment 110a of the conducting body. The second antenna port 122 has two feed points dividing an opposite rectangle edge in a ratio 1:2:1, wherein each of said two feed points is arranged between the first segment 110a and a second segment 110b of the conducting body. This is to say, the positive and negative pole of each feed point are located on different segments 110a, 110b, as shown in FIG. 1c.

In FIG. 1d, the conducting body is rectangle-shaped and has three segments 110a, 110b, 110c. The first antenna port 121 has two feed points dividing a first rectangle edge in a ratio 1:2:1, wherein each of said two feed points is connected between a first segment 110a and a second segment 110b of the conducting body. The second antenna port 122 has two feed points dividing an opposite rectangle edge in a ratio 1:2:1, wherein each of said two feed points is connected between the first segment 110a and a third segment 110c of the conducting body.

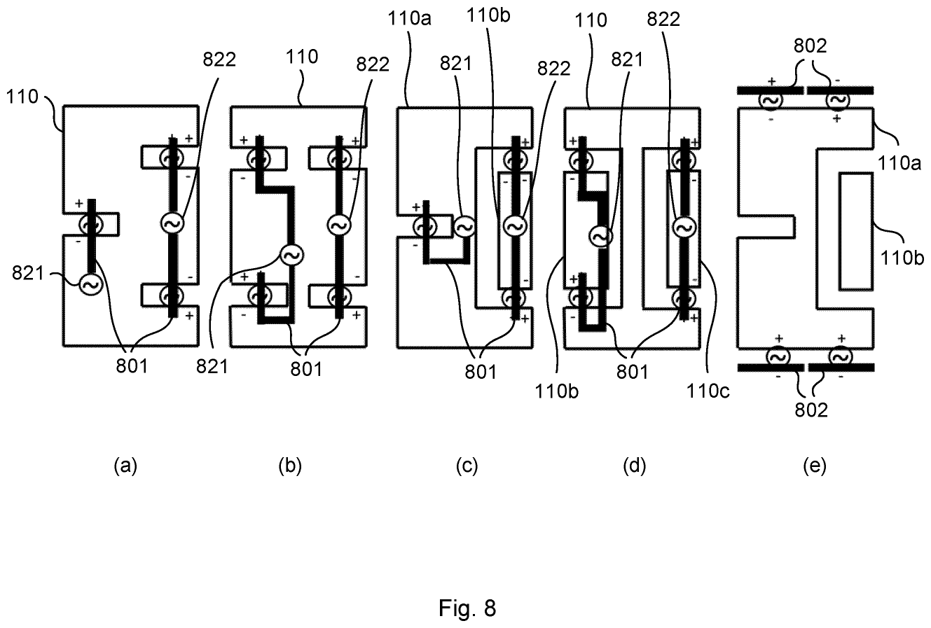

FIG. 8 shows, similar to FIG. 1, several planar antenna structures according to embodiments herein. The antenna structure in FIG. 8a includes, in addition to the planar conducting body 110 and the three feed points, two wave guides 801, which are co-planar with the conducting body 110. The wave guides 801 may be printed directly on a printed circuit board, or they may be provided as microstrip lines. The left-hand wave guide 801 interfaces inductively with the left feed point (with the defined polarization) and, in this way, brings about a downward shift from the feed point's vertically centered position to a possibly more accessibly positioned equivalent first feed point 821 and the other end of the wave guide 801. The first set of radiation modes can thus be excited by applying a suitable signal (drive signal) to the equivalent first feed point 821. The right-hand wave guide 801 interfaces inductively with the two right-hand feed points and has, near its center, an equivalent second feed point 822. To excite the second set of radiation modes, thus, it is sufficient to apply a signal at the equivalent second feed point 822.

The addition of the wave guide 801 according to FIG. 8a brings the potential benefit that the first and second antenna ports can be fed at fewer feed points, such as at a single feed point. Thus, the necessary number of feedlines from the feed network (or their total length) can be reduced.

FIGS. 8b, 8c and 8d illustrate further example routing patterns by which antenna feed points within each antenna port can be shifted or joined by co-planar wave guides that interface capacitively with the feed points on the conducting body 110. Equivalent effects and advantages can be expected as for the routing pattern in FIG. 8a.

FIG. 8e illustrates an arrangement where two feed points in an edge zone of the conducting body 110 are joined by an upper and a lower wave guide 802. The feed points are of the capacitive type and thus include a single pole each. Accordingly, the wave guide 802 used in FIG. 8e is qualitatively different from the wave guides 801 in FIGS. 8a, 8b, 8c and 8d in that it interfaces capacitively with the feed points on the conducting body 110.

FIG. 9 are side views (or cross sections) illustrating embodiments where the conducting body 110 has an overall non-planar shape. More precisely, the left and right edges of the conducting body 110 in FIG. 9a have been processed into an approximate L shape, so that the conducting body 110 has a resulting shape with three planar regions 901 (extending into the plane of the drawing) and two curved regions 902 (extending into the plane of the drawing). The processing may include bending or pressing a sheet of ductile conducting material. Similarly, each edge of the conducting body 110 in FIG. 9b has been bent into an approximate U shape. The bending of the conducting body 110 will likely modify the excitable radiation modes, possibly resulting in a spatially more complete radiating ability. It may as well improve the mechanical robustness of the antenna structure.

Well-performing antenna structures like those in FIG. 1 may be designed in view of information about the radiation modes, as visualized in FIG. 3. Such information may, in turn, be made available by computer simulations that implement electromagnetic Characteristic Mode Analysis (CMA). By way of introduction, it is recalled that any conducting object has its own set of radiation modes (or current modes, or characteristic modes), which are independent of any excitation source applied. Each radiation mode manifests itself as a pattern of surface currents on the object, by which charge is redistributed over the surface in an oscillatory manner. A radiating state of the conducting object can be expressed a superposition of a collection of the radiation modes. Each radiation mode further manifests itself as a different characteristic impedance, which is in general a frequency-variable quantity, from which information about the eigenfrequency (or resonating frequency) and the radiating bandwidth of the different current modes can be derived. The radiation modes can be separated into two different classes depending on their behavior and appearance: antenna modes and transmission-line modes. Whereas the antenna modes are efficient radiators, the transmission-line modes might represent good or poor radiating performance. From the point of view of antenna technology, the excitation of transmission-line modes should be avoided in cases where the radiated fields cancel in the far field. Further aspects of CMA are discussed in the references Manteuffel and Peitzmeier identified above.

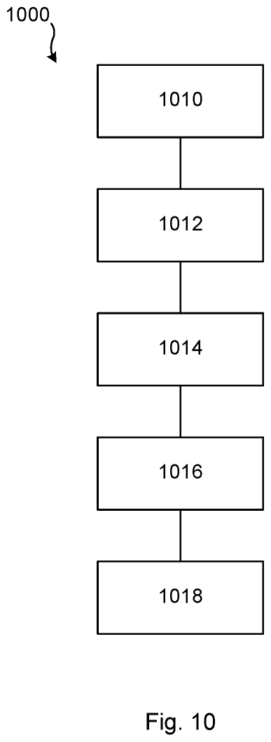

Turning finally to the third aspect of the present disclosure, a method 1000 of designing a multimode antenna will be described with reference to the flowchart in FIG. 10. The method 1000 may be performed partly by a human operator, partly with computer assistance, or the full method 1000 may be implemented as a computer program to be executed on a programmable processor or on a plurality of connected processors. The method 1000 enables the design of a multimode antenna with the advantageous properties discussed within the first aspect of this disclosure, that is, excellent antenna-port isolation over a substantial frequency range.

In a first step 1010 of the method 1000, a geometric description of the conducting body is obtained. The geometric description may include the lengths, widths, thicknesses etc. of the conducting body in physical units, so as to enable numerical solving of one or more partial differential equations (e.g., wave equation) that govern the excitation of radiation mode in the conducting body. The geometric description of the conducting body may further include indications of the materials used, the surrounding medium and so forth.

In a second step 1012, a plurality of radiation modes of the conducting body is simulated based on the geometric description. The simulation may include solving the governing partial differential equation(s) numerically, possibly using a CMA tool. Relevant information of each radiation modes uncovered by the simulation is retained, such as eigenfrequency, current pattern and impedance. No complete account of these quantities is necessary. Rather, to save processing power and storage capacity, such information that is unlikely to influence the subsequent identification steps 1014, 1016, and therefore less relevant, may be discarded. For example, instead of retaining a detailed current pattern, it may be sufficient to retain locations of local current maxima and minima. Similarly, the impedance of the radiation modes may be retained only for a frequency range that an operator has selected as being of interest.

In a third step 1014, a first set of radiation modes each of which satisfies an EBC at a common boundary curve are identified on the basis of the retained relevant information of the simulated radiation modes. Similarly, in a fourth step 1016, whose execution may overlap in time with the third step 1014, a second set of radiation modes each of which satisfies an MBC at said common boundary curve are identified. EBC and MBC have been defined above, as well as the meaning of “common boundary curve” in the present disclosure. Each of the identification steps 1014, 1016 may be understood as an attempt to find a set of radiation modes with eigenfrequencies at the lower boundary of the conducting body's spectrum and with reasonably similar current patterns, in the sense that suitable potential feed point locations are shared by all radiation modes in the set. The feed point locations may be considered suitable if they substantially coincide with the location of a current maximum of the radiation modes, indeed, since a current maximum is a location that is generally suitable for exciting the corresponding radiation mode using an oscillating signal. As noted in the description of FIG. 3, a number N of radiation modes with these properties is not necessarily the radiation modes with the N lowest eigenfrequencies. Rather, some of the radiation modes may need to be excluded (modes 7, 10 and 12 in the example of FIG. 3) if the locations of their current maxima deviate significantly from the majority of the radiation modes.

In a fifth step 1018, a geometric description of a first and a second antenna port 121, 122, which are respectively adapted for excitation of the first and the second set of radiation modes is provided. The geometric description may for example specify the positions of the respective feed point(s) of these antenna ports 121, 122. Together with the geometric description of the conducting body, the output of the fifth step 1018 constitutes—or can be routinely developed into—an instruction for manufacturing a conducting body 110 in a multimode antenna 100 with the desired properties. The instruction may be used initially to manufacture a prototype to be subjected to measurements and other verification steps before commercial production is initiated.

In some embodiments of the method 1000, the identifying steps 1014, 1016 include assessing the total frequency range that results from a candidate set of radiation modes. The assessment may be based on S-parameter data or efficiency data, as exemplified in FIG. 5.

In some embodiments, the identifying steps 1014, 1016 include balancing the first set's total angular coverage range and the second set's total angular coverage range. If the respective angular coverage ranges are approximately equal, the two antenna ports 121, 122 multimode antenna are suitable for use as transmit and receive ports of an antenna system. The availability of balanced angular coverage ranges is particularly desirable in mobile-broadband (MBB) base stations and Active Antenna System (AAS) antennas. Such systems normally require for the Rx and Tx antenna ports to have a uniform angular coverage range, so that uplink and downlink have comparable coverages. If the balancing in the identifying steps 1014, 1016 does not reach the desired degree of equality, a workaround solution may be to provide one multimode antenna with a −45° polarization and another multimode antenna one with +45° polarization.

In some embodiments, the identifying steps 1014, 1016 include classifying the simulated radiation modes into transmission-line modes and antenna modes. Reference is made to the above discussion concerning the properties of these mode types and their suitability in the context of a multimode antenna.

In still further embodiments, a further desirable aim to be considered in the identification steps 1014, 1016 is the degree of isolation (in dB) between the first and second antenna ports 121, 122. The isolation can be computed on the basis of the eigenfrequencies of the radiation modes in the respective sets. Whether a given degree of isolation is sufficient for the intended application can be determined, for example, on the basis of the expected performance of a feed network to be used with the multimode antenna 100, e.g., in terms of frequency peak width, spurious emissions.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A multimode antenna comprising:
a conducting body; and
a first and a second antenna port, which are respectively adapted for excitation of a first and a second set of radiation modes, all radiation modes sharing a common boundary curve at which an electric boundary condition, EBC, or a magnetic boundary condition, MBC, is satisfied,
wherein the first set consists of multiple radiation modes for which the EBC is satisfied at the common boundary curve, and
wherein the second set consists of multiple radiation modes for which the MBC is satisfied at the common boundary curve.

2. The multimode antenna of claim 1, wherein the EBC is satisfied if the electric field's tangential component vanishes at the common boundary curve.

3. The multimode antenna of claim 1, wherein the MBC is satisfied if the electric field's tangential component is continuous across the common boundary curve.

4. The multimode antenna of claim 1, wherein the first and second antenna ports are adapted for simultaneous excitation of multiple radiation modes of the first and second sets.

5. The multimode antenna of claim 4, wherein the first and second antenna ports are adapted for simultaneous excitation of at least three radiation modes of the first and second sets, respectively, wherein preferably the first and second antenna ports are adapted for simultaneous excitation of at least four radiation modes of the first and second sets, respectively, wherein preferably the first and second antenna ports are adapted for simultaneous excitation of at least six radiation modes of the first and second sets, respectively.

6. The multimode antenna of claim 5, wherein each of the first and second sets of radiation modes has a total radiation bandwidth of at least 24 GHz, preferably at least 28 GHz, more preferably at least 32 GHz, more preferably at least 36 GHZ, and most preferably at least 40 GHz.

7. The multimode antenna of claim 1, wherein each radiation mode of the first set is orthogonal to each radiation mode of the second set.

8. The multimode antenna of claim 1, wherein the common boundary curve coincides with a symmetry line of the conducting body.

9. The multimode antenna of claim 1, wherein:
each of the antenna ports has at least one feed point suitable for accepting a signal; and
said at least one feed point of each antenna port is so positioned on the conducting body as to favor excitation of either the first or the second set of radiation modes.

10. The multimode antenna of claim 9, wherein said at least one feed point of each antenna port is positioned at a current maximum in radiation modes of either the first or second set.

11. The multimode antenna of claim 9, wherein each feed point of the first antenna port is positioned in separation from all feed points of the second antenna port.

12. The multimode antenna of claim 9, wherein the second antenna port has two or more feed points.

13. The multimode antenna of claim 9, wherein:
the conducting body is rectangle-shaped and monolithic;
the first antenna port has a single feed point dividing a first rectangle edge in a ratio 1:1; and
the second antenna port has two feed points dividing an opposite rectangle edge in a ratio 1:2:1.

14. The multimode antenna of claim 9, wherein:
the conducting body is rectangle-shaped and monolithic;
the first antenna port has two feed points dividing a first rectangle edge in a ratio 1:2:1; and
the second antenna port has two feed points dividing an opposite rectangle edge in a ratio 1:2:1.

15. The multimode antenna of claim 9, wherein:
the conducting body is rectangle-shaped and segmented;
the first antenna port has a single feed point dividing a first rectangle edge in a ratio 1:1, said single feed point connected to a first segment of the conducting body; and
the second antenna port has two feed points dividing an opposite rectangle edge in a ratio 1:2:1, each of said two feed points connected between the first segment and a second segment of the conducting body.

16. The multimode antenna of claim 9, wherein:
the conducting body is rectangle-shaped and segmented;
the first antenna port has two feed points dividing a first rectangle edge in a ratio 1:2:1, each of said two feed points connected between a first segment and a second segment of the conducting body; and
the second antenna port has two feed points dividing an opposite rectangle edge in a ratio 1:2:1, each of said two feed points connected between the first segment and a third segment of the conducting body.

17. The multimode antenna of claim 9, wherein at least one of the antenna ports comprises two or more feed points coupled by a co-planar wave guide.

18. The multimode antenna of claim 1, wherein the conducting body is planar.

19. The multimode antenna of claim 1, wherein the conducting body comprises at least one planar region and one curved region.

20-23. (canceled)

24. A method of designing a multimode antenna which includes a conducting body, the method comprising:
obtaining a geometric description of the conducting body;
simulating, based on the geometric description, a plurality of radiation modes of the conducting body;
identifying a first set of radiation modes each of which satisfies an electric boundary condition, EBC, at a common boundary curve;
identifying a second set of radiation modes each of which satisfies a magnetic boundary condition, MBC, at said common boundary curve; and
providing a geometric description of a first and a second antenna port, which are respectively adapted for excitation of the first and the second set of radiation modes.

25. (canceled)
